(19) United States
(12) Patent Application Publication
(10) Pub. No.: US 2025/0165866 A1
(43) Pub. Date: May 22, 2025

(54) DETECTING MODEL DEVIATION WITH INTER-GROUP METRICS

(71) Applicant: THE TORONTO-DOMINION BANK, TORONTO (CA)

(72) Inventors: Jesse Cole Cresswell, TORONTO (CA); George Frazer Stein, Port Coquitlam (CA); Farnush Farhadi Hassan Kiadeh, TORONTO (CA); Zhaoyan Liu, TORONTO (CA); Ji Xin, TORONTO (CA)

(21) Appl. No.: 18/949,328

(22) Filed: Nov. 15, 2024

Related U.S. Application Data
(60) Provisional application No. 63/600,643, filed on Nov. 17, 2023.

(51) Int. Cl. G06N 20/00

(52) U.S. Cl. CPC G06N 20/00

(57) ABSTRACT

A computer model is monitored during operation to evaluate performance of the model with respect to different groups evaluated by the model. Performance for each group is evaluated to determine an inter-group performance metric describing how model predictions across groups differs. A threshold for excess inter-group performance differences can be calibrated using withheld training data or out-of-time data to provide a statistical guarantee for detecting meaningful variation in inter-group performance metric differences. When the inter-group performance exceeds the threshold, the computer model may be considered to deviate from expected behavior and the monitoring can act to correct its operation, for example, by modifying actions that may otherwise occur due to model predictions or by initiating model retraining.

### CROSS-REFERENCE TO RELATED APPLICATION

This application claims the benefit of U.S. Provisional Application No. 63/600,643, filed Nov. 17, 2023, the contents of which is hereby incorporated by reference in its entirety.

### BACKGROUND

This disclosure relates generally to evaluating model performance, and particularly to evaluating model performance with inter-group metrics.

Computer models are generally trained with respect to a set of training data and applied to generate assessments for a set of inference data. Before using such a model for automated decision-making or recommendation, the models in many cases may also be evaluated for its treatment of different groups within the training data to ensure the models do not improperly include favor or bias for one group relative to another. However, while these models may be extensively verified before being used for live applications, after a model is implemented, it may be unknown whether the model continues to perform well without introducing improper bias over time. Over time, new data may diverge from the distribution of the training data, such that, while the trained model performed well on the training data, the character of the data distribution has changed. Moreover, even when the overall performance of the model appears accurate (i.e., the overall training objective appears to be performing well), models may introduce improper bias over time with respect to particular groups (i.e., subsets within the data). In addition, natural patterns in the data typically yield differences in group metrics that differ for different models, such that setting a static threshold for group differences typically will not accurately account for particularities of a given model and its data.

### SUMMARY

To monitor application of a computer model over time, the computer model is monitored with respect to its

After training, a computer model may be applied to data sets to determine predictions for various data samples. When the computer model is live, each data set may represent a particular time period, such as two weeks, a month, or a quarter, and the evaluations performed by the computer model during that period. The predictions by the computer model may then be evaluated to determine performance metrics for each group in the data set and a corresponding inter-group performance metric describing the difference of the performance metric across groups. For example, the performance metric may be a false positive rate indicating the frequency that a positive prediction by the model is found to err. The corresponding inter-group performance metric may describe the difference in false positive rate between the group with the highest and the group with the lowest false positive rate.

To determine when the inter-group performance metric is meaningful, rather than set an absolute value for the inter-group performance metric as a threshold for detecting an unexpected value, the inter-group performance metric is calibrated based on the inter-group performance of a number of calibration data sets, which may include withheld data samples from the training set and an “out-of-time” data sample for data obtained after the time range represented in the training data. To obtain additional calibration data sets, data samples may also be sampled (e.g., “bootstrapped”) to create synthetic subsets of data to represent time periods that may be used in practice when applying the model.

During application of the model, the inter-group performance metric is determined for various time periods and compared with the threshold. When the inter-group performance metric exceeds the threshold for a number of time periods, the model may be identified as deviating from its expected performance for the group differences, and corrective action may be taken. This may include retraining the model to account for current data set characteristics or modifying actions recommended by the model, for example by preventing automatic application of actions corresponding to model recommendation, further manual review, or evaluation by a separate model.

### BRIEF DESCRIPTION OF THE DRAWINGS

FIG. 1 illustrates a computer modeling system for training and applying a computer model, according to one embodiment.

FIG. 2 shows an example timeline for deploying a model with inter-group monitoring, according to one embodiment.

FIG. 3 shows an example data flow for determining an inter-group performance metric for a data set, according to one embodiment.

FIG. 4 shows an example data flow for calibrating an inter-group performance threshold, according to one embodiment.

FIG. 5 is an example flowchart for monitoring a computer model with an inter-group performance threshold, according to one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Architecture Overview

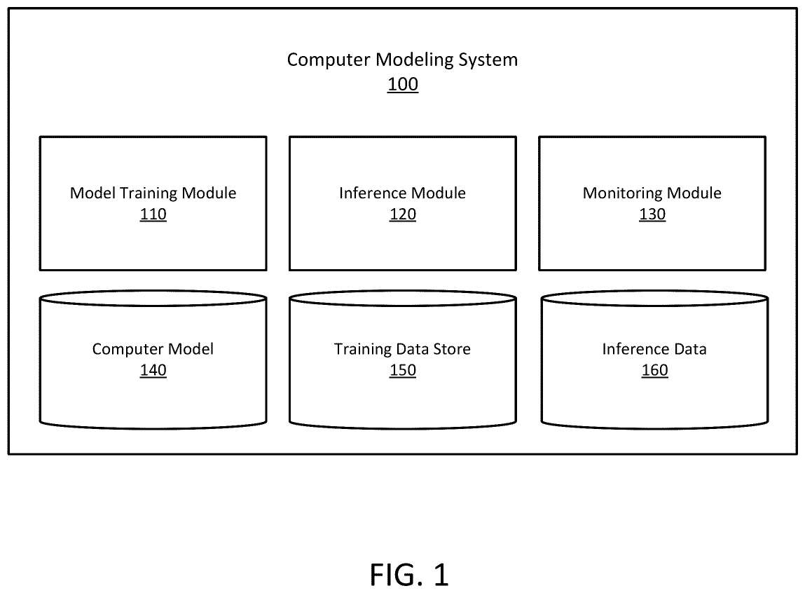

FIG. 1 illustrates a computer modeling system 100 for training and applying a computer model 140, according to one embodiment. The computer model 140 may be any type of computer-trained model with parameters learned through a training process that evaluates features of an input, termed a data sample or a data instance, to output a prediction. The prediction may be a classification, a score, or other evaluation of the data sample, which may vary in different embodiments as further discussed below. The computer modeling system 100 includes a set of computing modules for training and applying the computer model 140, along with a training data store 150 including a set of training data for training the parameters of the computer model 140. Alternative embodiments may include more, fewer, or different components from those illustrated in FIG. 1, and the functionality of each component may be divided between the components differently from the description below.

Additionally, the computer modeling system 100 may also communicate with one or more other systems to exchange information, which are not shown in FIG. 1 for convenience. The computer modeling system 100 may communicate with other systems and various user devices, for example, to receive training or other data, to receive input data samples for inference analyses, to receive inputs from a user of the computer modeling system 100, to transmit results of inference analyses, and so forth.

The computer modeling system 100 may use a computer model 140 to automatically form a prediction for a received data sample and may automatically apply a related action based on the prediction. The computer model 140 is a machine-learning model that is trained to generate the prediction, typically as a score, for the data sample. The scoring may represent a classification (e.g., higher scores belonging to a class and lower scores not belonging to a class) prediction, and the computer model in some embodiments may output a plurality of predictions (e.g., for different classes or different outcomes).

In various embodiments, the computer model is trained to predict likely events to occur. These events may be after an action is performed by the computing system or may be likely events irrespective of an action (e.g., that may then inform whether to take a certain action). For example, the data samples may describe characteristics of a patient in a medical setting, and the outcome may represent a likelihood of a particular outcome within a timeframe, such as all-cause mortality within a year, cardiac event risk within 6 months, and so forth. As such, the data samples may be used to predict outcomes that can be known in the future (i.e., whether the predicted event did or did not occur). As another example, in financial contexts, the computer model 140 may predict a likelihood of insolvency in the following three or six months, late or delinquent payment in the next month, and so forth. As such, in these examples the labels for the data samples are typically not available at the time the data samples are evaluated but may become available at a later time (e.g., when the predicted event does or does not occur).

The computer model 140 may, in various embodiments, use heuristics, statistics, advanced analytics, machine learning, artificial intelligence, or other methods for generating predictions. The computer model 140 may be trained with labeled data samples in a training data set, e.g., data samples stored by the training data store 150. During training, the computer model parameters may be updated to improve performance of the computer model predictions with respect to labels for the data samples. The comparison of the computer model prediction relative to the data sample label may be evaluated as a loss or objective function and used to modify parameters of the computer model. For example, the parameters of the computer model may be updated with backpropagation of an error/loss and with an update of the parameters according to any suitable training algorithm, such as gradient descent.

In some embodiments, the computer model 140 is trained with a model training module 110 using training data samples stored in the training data store 150. Generally, the training data includes training data samples used to train parameters of the computer model 140 and additionally includes data samples that may be used for calibration of various aspects of the computer model, including of an inter-group performance threshold discussed below.

Once trained, the computer model 140 may be used, according to various embodiments, in one or more applications for authorization and access to systems, risk analysis (e.g., system intrusion), financial and/or credit risk analysis, medical risk analysis (mortality or long-term health diagnoses), image processing classification, or the like. In other embodiments, the computer model 140 may be used in any other suitable application in which risk or uncertainty may be quantified.

An inference module 120 receives new data samples and evaluates the received data samples with respect to the computer model 140. Based on the prediction by the computer model 140, the inference module 120 may automatically take one or more actions associated with the prediction. The specific action may vary according to the embodiment and the prediction. For example, the inference module 120 may transmit notifications to users of the computer modeling system 100 based at least, in part, on a prediction by the model, may enable permissions for users of the computer modeling system to access information or further actions, may associate the class with the data sample, recommend treatment, grant/deny access for services, and so forth. Data samples on which inference is performed and related predictions may be stored as a set of inference data 160.

In many types of applications, performance of the model may be monitored with respect to various outcomes for different groups within the data by a monitoring module 130. The monitoring module 130 thus evaluates whether performance of the model across different groups remains acceptable over time. The groups may be defined by different features or characteristics of the data samples and may include characteristics for which the model performance generally should not yield different results across groups of data samples. In addition, in some embodiments, the characteristics defining the groups may not be provided to the computer model as an input feature. For example, inter-group performance for groups may be evaluated in some embodiments without expressly providing the group membership to the model itself as a feature.

In addition, the groups may be defined by any suitable characteristic for which group differences in model performance is monitored. Such groups may be defined, e.g., by characteristics irrelevant to the analysis or for which for legal and/or ethical reasons the difference in group bias and/or fairness should be monitored and corrected. That is, the groups define different subsets of data for which the model should not meaningfully differ in comparative performance metrics over time. These may include, for example, personal characteristics such as age, gender, sex, and so forth, along with any other characteristics of interest.

The monitoring module 130 monitors inter-group performance of the model and may modify actions of the model when the inter-group performance is determined to meaningfully deviate. Particularly, the monitoring module 130 may determine an inter-group performance metric for the model as applied to a particular data set. After deployment of the computer model 140 (i.e., during its operation) the monitoring module 130 retrieves data samples from the inference data 160 to evaluate the inter-group performance metric of the computer model 140. The inference data set evaluated by the monitoring module 130 may include data samples for a particular time period evaluated by the computer model 140. The inter-group performance metric is compared with an inter-group performance threshold to determine whether the performance significantly deviates from expectation. The inter-group performance threshold may be calibrated before implementation of the computer model with a set of calibration data, which may include holdout data from the training data set along with out-of-time data. These and other aspects of the inter-group performance evaluation are discussed further below.

When the computer model 140 is identified to deviate in its performance across classes, the monitoring module 130 may also initiate corrective action. First, the monitoring module 130 may provide an alternative way for determining an appropriate action for a data sample when the computer model 140 exhibits excess inter-group performance difference (i.e., a deviation). As such, the monitoring module 130 may prevent subsequent use of the computer model 140 after detecting the deviation or may prevent automatic application of an action normally resulting from the computer model prediction. Instead, data sample(s) for a group associated with the relatively different performance may be reviewed by a different computer model or by manual review to determine appropriate action.

As such, when the computer model 140 is performing within expectation for inter-group performance, the corresponding action may thus be automatically applied, such that the higher resource use or other investment of alternate analysis of actions by the monitoring module 130 are applied only when the computer model deviates in its inter-group performance.

As one example, the monitoring module 130 may comprise applying a more sophisticated computer model to the data sample. The more sophisticated computer model may include more complex input features and/or model architecture (e.g., more parameters). As such, the computer model 140 in some embodiments may represent a “first line” classification that, when sufficiently confident and operated well, can be automatically applied. When the monitoring module 130 identifies that it is not performing within the inter-group performance threshold, data samples may be evaluated alternatively.

As another example, the monitoring module 130 may provide an interface for manual review by a user of the computer modeling system 100. For example, the monitoring module 130 may transmit information about the data sample to a user of the computer modeling system 100 to manually identify a correct prediction and/or action for the data sample. In some embodiments, the monitoring module 130 may additionally transmit the prediction by the computer model 140 or other model information, alongside the data sample for human evaluation of the data sample and selection of a relevant associated action.

As another corrective action, the monitoring module 130 may also use the detected deviation of the inter-group performance to signal retraining of the computer model 140. The computer model 140 may be retrained (e.g., by the training module 110) in various ways in different embodiments. In one example, the computer model 110 may be retrained by adding additional or different data to the training data set for the computer model 110, such as the data for the data set (e.g., a time period) for which the computer model exhibited inter-group performance in excess of the threshold. In another example, a parameter describing a decision threshold (e.g., an activation function) for the model may be modified based on the identified inter-group performance.

Finally, components of the computer modeling system 100 are shown in one system in FIG. 1 for convenience, but in practice may be dispersed at different systems. In some embodiments, the computer model 140 may be trained at one computing system, deployed (i.e., perform inference with inference module 120) at another computing system, and another computing system may perform monitoring functions of the monitoring module 130.

### Inter-Group Performance Metrics

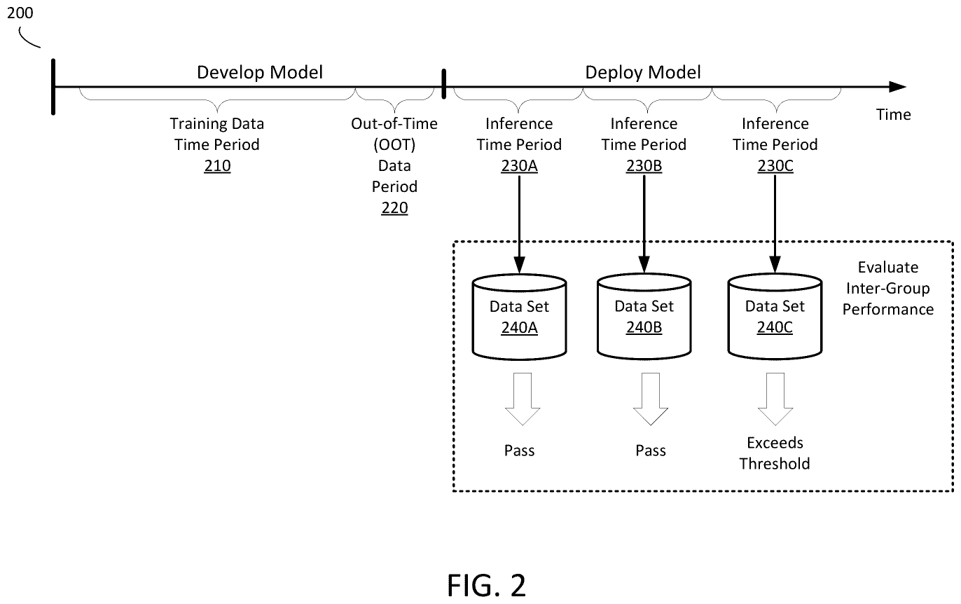

FIG. 2 shows an example timeline 200 for deploying a model with inter-group monitoring, according to one embodiment. In many cases, data samples for a computer model are gathered over a period of time, such that the training data may generally include data from a training data time period 210. Typically, during model development the model is trained to perform well on the training data from the training data time period 210. The developed models may also be evaluated for a number of additional metrics, such as the performance of the model across different subgroups of training data, such that the model performance, with respect to the data distribution and other characteristics of the data in the training data, are generally verified as acceptable for use. In highly regulated environments, development of these models may include months or years of data samples in the training data time period 210.

In addition to the training data used to directly train the model, additional data before deployment may be captured that represents a time period not captured by the training data. This training data is “out-of-time” (OOT) with respect to the training data and may be used in various ways to verify and/or calibrate performance of the model. That is, acceptable model performance, based on a time range of the training data, can be verified to continue to apply to the data samples of the out-of-time data period 220. As discussed further below, withheld training data and/or OOT data may be used to calibrate the expected inter-group performance of the model.

After the model is trained and verified, the model is deployed and may be applied to new data samples. As the model is applied, the data samples evaluated by the model may be grouped to various time periods for evaluation with respect to inter-group performance. Data samples evaluated in a first inference time period 230A may form a first data set 240A, data samples in a second inference time period 230B may form a second data set 240B, data samples evaluated in a third inference time period 230C may form a third data set 240C, and so forth. At the time periods 230A-C, the computer model may be deployed and currently being used to form predictions for data samples on which actions may automatically be selected and/or performed. As such, the inter-group performance monitoring provides a way to determine whether, in practice and over time, the resulting performance of the model remains within expectation. The monitoring module 140 evaluates the inter-group performance of each data set 240A-C to determine whether the inter-group performance metric for each data set (e.g., each particular time period) remains within the inter-group performance threshold defining expected behavior.

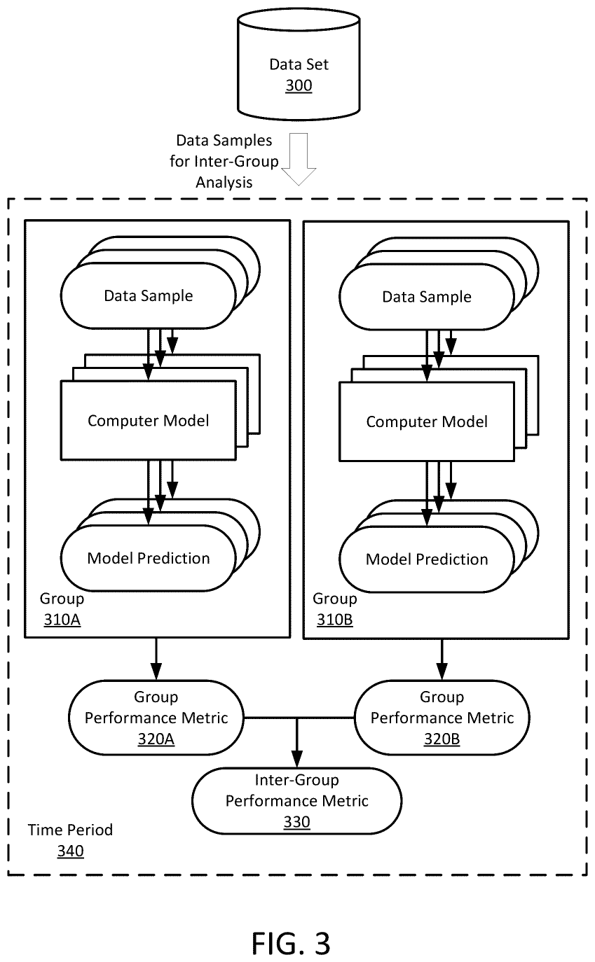

FIG. 3 shows an example data flow for determining an inter-group performance metric 330 for a data set 300, according to one embodiment. This data flow may be performed, for example, by a monitoring module 130 as discussed above. Although noted in FIG. 2 as related to a particular time period, the inter-group performance metric 330 may be determined for a data set that is not necessarily related to a specific time range or time period.

Initially, the data set may be separated to identify the data samples that belong to respective groups 310A-B. Two groups are shown in this example, although any number of groups may be evaluated in practice. Typically, group membership is exclusive, such that each data sample belongs to one group 310. Each data sample within a group is evaluated by the computer model to result in a corresponding model prediction. Depending on the performance metric used in a particular embodiment, a known label for the data sample may also be associated with the data sample. For training/calibration data, the data samples may be labeled with a known outcome of the training data sample. In situations in which the model predicts a particular event, the label may be obtained subsequent to the prediction by determining whether the predicted event occurs or does not occur within the prediction timeframe.

For each group 310A-B, a respective group performance metric 320A-B is determined that describes the performance of the computer model with respect to that group. The particular performance metric used by vary according to the particular embodiment, and generally describes a measurement of the performance of the computer model relevant to group-related differences. In some instances, the performance metric may include the overall prediction value for the group (i.e., the frequency that the model predicts a given outcome for each group). This may represent, for example, situations in which the overall actions performed by the model should be similar for each group.

In other instances, the performance metric may measure the frequency that the model errs in its prediction. As such, the group performance metric 320 may include a false positive or false negative rate (or both) for the respective group. The false positive rate may describe the frequency that the model predicted an event and a comparison of the frequency that the model was correct (i.e., the false positive rate as a proportion of all positive predictions). Similarly, the false negative rate may describe the frequency that the model predicted an event would not occur and the frequency that this prediction was incorrect. These group performance metrics may be used, for example, when the rates of predicted events for groups of data samples may vary, but that the error should be similar between groups.

Although these are examples of particular types of measurements that may be used for group performance metrics 320, various embodiments may use any suitable means for measuring performance of the model with respect to the groups 310.

From the individual group performance metrics 320, the inter-group performance metric 330 is determined by comparing the group performance metrics 320 with one another. The inter-group performance metric 330 may be determined in various ways to describe the difference/variation of the group performance metrics 320 across the different groups. As discussed in this application, a relatively smaller inter-group performance metric represents a smaller difference in the group performance metrics 320 across the relevant groups, indicating the performance of the model is generally more similar across the groups along the designated performance metric. In one embodiment, the inter-group performance metric 330 is calculated as a maximum difference between the group performance metrics 320 (i.e., the difference between the highest group performance metric 320 and the lowest group performance metric). In various embodiments, the inter-group performance metric 330 may also be calculated as a variance, standard deviation, or other statistical measure of the range of values of the group performance metrics 320.

### Setting an Inter-Group Performance Threshold

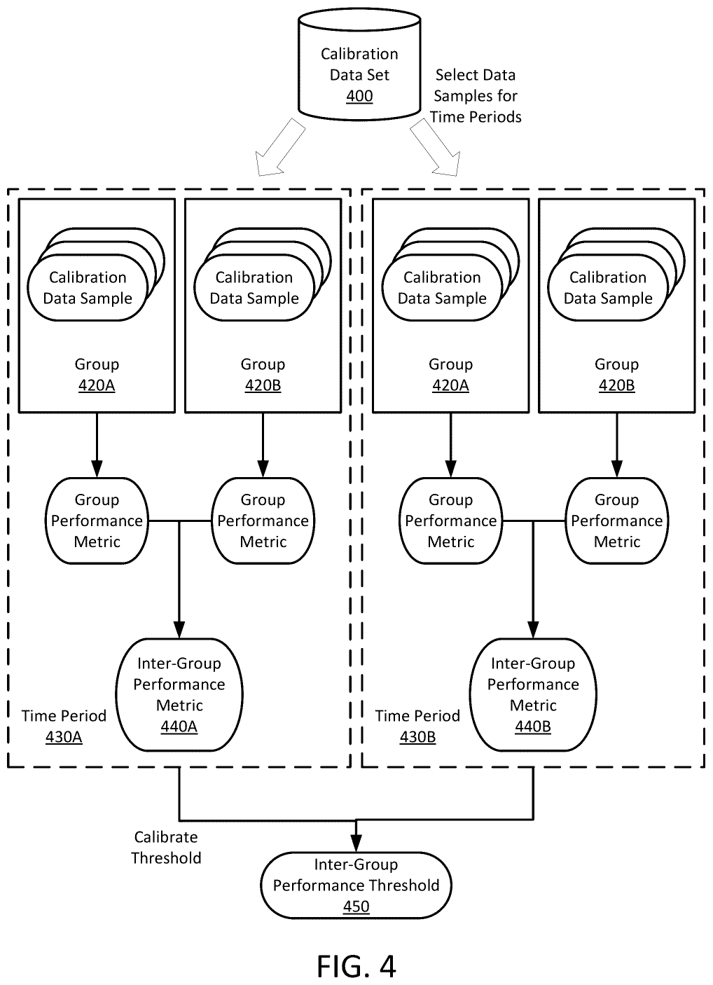

FIG. 4 shows an example data flow for calibrating an inter-group performance threshold 450, according to one embodiment. In general, the particular values for the inter-group performance metric may be expected to vary for a given computer model for different data samples of different time periods, such as shown in FIG. 2. Different time periods may have different numbers of data samples for different groups that may present different features and may yield different model outputs. Similarly, different models, applied to the same data sets, may also permissibly vary in the resulting inter-group performance metrics. Accordingly, in various embodiments, an inter-group performance threshold 450 used to determine whether a particular measured inter-group performance metric 440 represents a meaningful deviation from “normal” or “expected” variation is calibrated using a plurality of data sets from a calibration data set 400. The calibration data set 400 may include known training data withheld from training of the model and may include OOT data samples from before implementation of the model as discussed in FIG. 2. Subsets from the calibration data set 400 may be selected to evaluate the inter-group performance metric 440 of the different subsets. In one embodiment, the subsets may include data samples from different time periods such as time period 430A and time period 430B. Within each subset, the data samples may be grouped according to the groups 420A-B that are of interest and the respective group performance metrics and resulting inter-group performance metric 440A-B determined for that subset, for example as discussed with respect to FIG. 3. A plurality of different subsets of the calibration data may thus be used to calculate respective inter-group performance metrics 440A-B.

Although, in this example, the subsets represent a first time period 430A and a second time period 430B, in various embodiments the subsets may represent the same (or overlapping) time periods with differing data samples. That is, the subsets of the calibration data set 400 are selected to determine the expected extent to which the inter-group performance metrics 440A-B may differ if drawn from the same distribution as the calibration data set 400. In some embodiments, the different subsets may each be constructed with random samples from the calibration data set 400 and may differ in quantity, such that different subsets have different quantities. As such, the different subsets may represent “bootstrapping” from the calibration data set 400 to generate the varying inter-group performance metrics 440 that represent different potential subsets drawn from the calibration data set 400.

The inter-group performance threshold 450 is determined based on the plurality of inter-group performance metrics 440. Although two subsets are shown in FIG. 4 for time periods 430A-B, in practice many more subsets may be evaluated to calibrate the inter-group performance threshold. The inter-group performance threshold 450 may be set in various ways and may be set in a way that provides a statistical guarantee to the specified inter-group performance threshold 450. In one embodiment, the inter-group performance threshold 450 is set to a value such that a specified portion of the inter-group performance metrics are within the inter-group performance threshold 450. For example, the inter-group performance threshold 450 may be set, such that 95%, 99%, or 99.5% of the inter-group performance metrics 440 are within the inter-group performance threshold 450. In some embodiments, a statistical distribution, such as a Gaussian distribution, is estimated for the inter-group performance metrics 440 and used to select the inter-group performance threshold 450. The statistical distribution may be used to select an inter-group performance threshold 450, such as a specified percentile or statistical likelihood. By setting the inter-group performance threshold 450 based on the various groups of inter-group performance metrics, the inter-group performance threshold 450 may be used with an objective, statistical guarantee for measuring what constitutes excess (i.e., unexpected) inter-group performance variation beyond that which is expected from the calibration data. This adaptive approach with a dynamically-measured threshold enable statistical power for the inter-group performance threshold that may not be possible with statically-set thresholds.

### Monitoring With an Inter-Group Performance Threshold

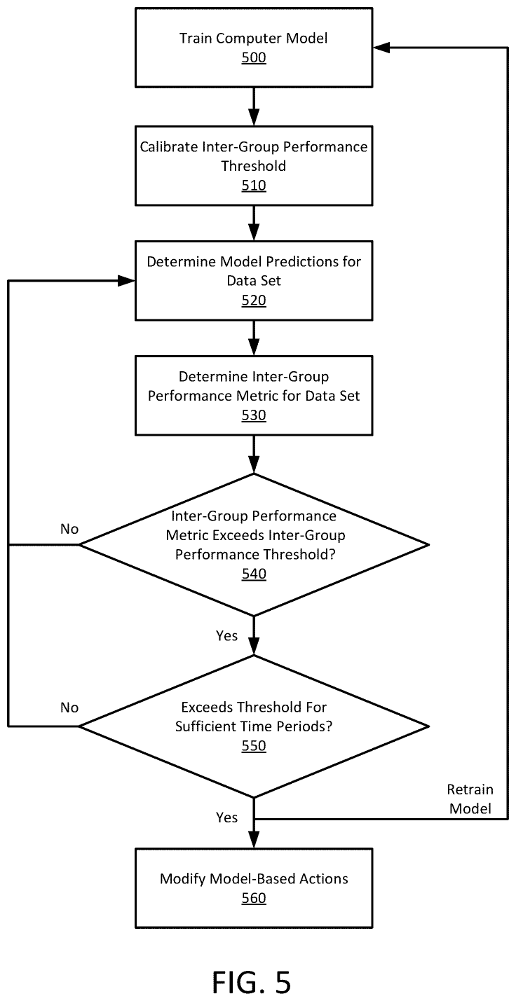

FIG. 5 is an example flowchart for monitoring a computer model with an inter-group performance threshold, according to one or more embodiments. The method shown in FIG. 5 may be performed by the computer modeling system 100 as shown in FIG. 1 and may include more or fewer steps in varying embodiments.

Initially, a computer model may be trained 500 with a training data set, such that parameters of the model are optimized for prediction of the training data set. The trained model may also be validated and otherwise calibrated for deployment and operation. To monitor the model as it performs inference on new data sets, the inter-group performance threshold is calibrated 510 with a calibration data set to determine the performance threshold that indicates deviation of the model from “normal” or “expected” inter-group performance differences. The inter-group performance threshold may be calibrated 510 as discussed above, such as with a plurality of subsets of a calibration datasets, which may include data samples in different time periods and subsampled from the calibration dataset.

As the computer model is deployed and used for inference, the computer model may be monitored by evaluating the performance of individual data sets applied to the model. A data set for evaluation is identified and the predictions of the model are determined 520. When the monitoring is performed after inference (e.g., after a time period of model operation as shown in FIG. 2), the data samples and respective predictions may be retrieved from a data store, such as inference data 160 shown in FIG. 1. In addition, the related results for the data samples may also be determined in configurations in which the performance metrics evaluate the correctness of the model predictions. These results, in some embodiments, may not exist until the allowed time for the predicted event completes (e.g., whether a cardiac event occurs within the subsequent 3 months).

Using the model predictions for the data samples, the data samples are identified in association with respective groups and the group performance metrics for each group determined for the group within the data set. The inter-group performance metric is determined 530 based on the group performance metric as discussed above. The inter-group performance metric for the data set is then compared with the inter-group performance metric to determine whether the inter-group performance metric exceeds 540 the inter-group performance threshold. When the inter-group performance metric exceeds the threshold, this may indicate that respective inter-group predictions by the model are exhibiting a significant difference relative to expected performance. When the threshold is calibrated as discussed above, the significance of the difference can be statistically quantified, enabling guarantees about the relative likelihood (or unlikelihood) that the threshold is expected to be exceeded.

In some embodiments, the threshold is evaluated for several time periods to confirm that the excess inter-group performance metric was not an outlier. As such, in some embodiments, the inter-group performance metric may be evaluated to exceed 550 the inter-group performance threshold for a number of evaluations (e.g., for sequential time periods), before determining that the model's performance deviates. When the model's performance is determined to deviate (e.g., the inter-group performance exceeds the inter-group performance), the monitoring may then affect operation of the model and its resulting actions. For example, the actions that would normally occur when the model forms a particular prediction may be modified 560, such as by escalating the prediction to a human evaluator or a different model as discussed above. The modification 560 of the model-based action may be performed for any prediction by the model or may be particularly performed for data samples of a group more significantly affected by the model performance (i.e., the group associated with a worse group performance metric). In some embodiments, the data samples associated with the group performing comparatively well may continue to be automatically acted on based on the model results. In addition to modifying 560 the model-based actions, when the threshold is exceeded, it may also be used to signal retraining of the model, for example to retrain the model with updated training data (e.g., including the data set(s) indicating a deviation) or adjusting parameters resulting in inter-group metric differences.

Finally, in some embodiments, multiple inter-group performance thresholds may be set that represent different statistical likelihoods, such that depending on which threshold is exceeded, different responses are taken. As one example, when a first inter-group performance threshold is exceeded, data samples for a particular group may be manually reviewed or escalated for alternate evaluation. Then, if a second inter-group performance threshold is exceeded for a sufficient number of time periods, application of the model may be halted for retraining the computer model to remediate the inter-group performance difference.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for detecting inter-group performance deviation of a computer model, comprising:
a processor configured to execute instructions; and
a non-transitory computer-readable memory having a set of instructions executable by the processor for:
identifying a set of model predictions for a set of data samples applied to a trained computer model, each data sample being associated with at least one group of a plurality of groups;
determining a plurality of group performance metrics, each corresponding to one of the plurality of groups based on the model predictions for data samples associated with the respective group;
determining an inter-group performance metric for the computer model based on the plurality of group performance metrics;
determining that the inter-group performance metric exceeds an inter-group performance threshold calibrated based on a plurality of calibration inter-group performance metrics; and
responsive to the determination that the inter-group performance metrics exceeds the inter-group performance threshold:
identifying an action selected for a current data sample based on a model prediction of the model applied to the data sample; and
modifying the action based on a group associated with the data sample.

2. The system of claim 1, wherein the current data sample is not included in the plurality of data samples.

3. The system of claim 1, wherein modifying the action comprises preventing automatic application of the action based on the model prediction.

4. The system of claim 1, wherein modifying the action comprises escalating the current data sample for manual review.

5. The system of claim 1, wherein the inter-group performance metric is a difference in false positive rate.

6. The system of claim 1, wherein the inter-group performance metric is determined for a plurality of sequential time periods and retraining the at least one parameter of the computer model is performed when the inter-group performance metric is exceeded for the plurality of sequential time periods.

7. The system of claim 1, wherein the plurality of calibration inter-group performance metrics are determined based on one or more data sets associated with time periods earlier than the set of data samples.

8. The system of claim 1, the instructions further comprising calibrating the inter-group performance threshold by:
estimating a probability distribution for the plurality of calibration inter-group performance metrics; and
setting the inter-group performance threshold to a threshold percentile of the probability distribution.

9. The system of claim 1, the instructions further comprising calibrating the inter-group performance threshold by:
determining a first subset and a second subset of data samples of a calibration data set by sampling from the calibration data set;
determining a first calibration inter-group performance metric for the first subset and a second calibration inter-group performance metric for the second subset, the first and second calibration inter-group performance metrics included in the plurality of inter-group performance metrics; and
setting the inter-group performance threshold based on the plurality of inter-group performance metrics.

10. A method for detecting inter-group performance deviation of a computer model, comprising:
identifying a set of model predictions for a set of data samples applied to a trained computer model, each data sample being associated with at least one group of a plurality of groups;
determining a plurality of group performance metrics, each corresponding to one of the plurality of groups based on the model predictions for data samples associated with the respective group;
determining an inter-group performance metric for the computer model based on the plurality of group performance metrics;
determining that the inter-group performance metric exceeds an inter-group performance threshold calibrated based on a plurality of calibration inter-group performance metrics; and
responsive to the determination that the inter-group performance metrics exceeds the inter-group performance threshold:
identifying an action selected for a current data sample based on a model prediction of the model applied to the data sample; and
modifying the action based on a group associated with the data sample.

11. The method of claim 10, wherein the current data sample is not included in the plurality of data samples.

12. The method of claim 10, wherein modifying the action comprises preventing automatic application of the action based on the model prediction.

13. The method of claim 10, wherein modifying the action comprises escalating the current data sample for manual review.

14. The method of claim 10, wherein the inter-group performance metric is a difference in false positive rate.

15. The method of claim 10, wherein the inter-group performance metric is determined for a plurality of sequential time periods and retraining the at least one parameter of the computer model is performed when the inter-group performance metric is exceeded for the plurality of sequential time periods.

16. The method of claim 10, wherein the plurality of calibration inter-group performance metrics are determined based on one or more data sets associated with time periods earlier than the set of data samples.

17. The method of claim 10, the method further comprising calibrating the inter-group performance threshold by:
estimating a probability distribution for the plurality of calibration inter-group performance metrics; and
setting the inter-group performance threshold to a threshold percentile of the probability distribution.

18. The method of claim 10, the method further comprising calibrating the inter-group performance threshold by:
determining a first subset and a second subset of data samples of a calibration data set by sampling from the calibration data set;
determining a first calibration inter-group performance metric for the first subset and a second calibration inter-group performance metric for the second subset, the first and second calibration inter-group performance metrics included in the plurality of inter-group performance metrics; and
setting the inter-group performance threshold based on the plurality of inter-group performance metrics.

19. A non-transitory computer-readable medium, the non-transitory computer-readable medium comprising instructions executable by a processor for:
identifying a set of model predictions for a set of data samples applied to a trained computer model, each data sample being associated with at least one group of a plurality of groups;
determining a plurality of group performance metrics, each corresponding to one of the plurality of groups based on the model predictions for data samples associated with the respective group;
determining an inter-group performance metric for the computer model based on the plurality of group performance metrics;
determining that the inter-group performance metric exceeds an inter-group performance threshold calibrated based on a plurality of calibration inter-group performance metrics; and
responsive to the determination that the inter-group performance metrics exceeds the inter-group performance threshold:
identifying an action selected for a current data sample based on a model prediction of the model applied to the data sample; and
modifying the action based on a group associated with the data sample.

20. The computer-readable medium of claim 19, wherein the current data sample is not included in the plurality of data samples.
